(19) United States
(12) Patent Application Publication
(10) Pub. No.: US 2024/0389676 A1
(43) Pub. Date: Nov. 28, 2024

(54) AEROSOL PROVISION SYSTEM

(71) Applicant: NICOVENTURES TRADING LIMITED, London (GB)

(72) Inventors: Patrick Moloney, London (GB); Sean Lukan, London (GB)

(21) Appl. No.: 18/694,462

(22) PCT Filed: Aug. 18, 2022
(86) PCT No.: PCT/GB2022/052145

§ 371 Date: Mar. 22, 2024

Related U.S. Application Data
(63) Continuation of application No. 17/448,831, filed on Sep. 24, 2021.

(51) Int. Cl. A24F 40/60; A24F 40/40; A24F 40/53

(52) U.S. Cl. CPC A24F 40/60; A24F 40/40; A24F 40/53

(57) ABSTRACT

A feedback portion (200) for use in an aerosol provision system (300). The feedback portion (200) may be supplied with a given aerosol provision system (1), or part thereof such as a cartridge (2) or mouthpiece (33). The feedback portion (200) may be configured to output electrical charge feedback, to a user of the aerosol provision system, in response to a predetermined criterion being satisfied. The feedback portion (200) may also be configured to output electrical charge feedback to enhance the flavour of any particular type of flavoured aerosolisable material which is configured to be delivered to the user when the aerosol provision device is being operated for generating an aerosol.

### FIELD

The present disclosure relates to aerosol provision systems such as, but not limited to, nicotine delivery systems (e.g. electronic cigarettes and the like).

### BACKGROUND

Electronic aerosol provision systems often employ an electronic cigarette (e-cigarette) or more generally an aerosol provision device. Such an aerosol provision system typically contains aerosolisable material (also called aerosol-generating material), such as a reservoir of fluid or liquid containing a formulation, typically but not necessarily including nicotine, or a solid material such as a tobacco-based product, from which a vapour/aerosol is generated for inhalation by a user, for example through heat vaporisation. Thus, an aerosol provision system will typically comprise a vaporiser (also called an aerosol generator), e.g. a heating element, arranged to aerosolise a portion of aerosolisable material to generate a vapour.

Once a vapour has been generated, the vapour may be passed through flavouring material to add flavour to the vapour (if the aerosolisable material was not itself flavoured), after which the (flavoured) vapour may be then delivered to a user via a mouthpiece from the aerosol provision device.

A potential drawback of existing aerosol provision systems and associated aerosol provision devices is that, not least for those with a visual impairment, it can be challenging for the user to garner any feedback whilst using the aerosol provision system in a noticeable and quick manner. Various approaches are therefore described herein which seek to help address or mitigate some of these issues, through the use of a different, non-visual, form of feedback, which utilises electrical charges which are delivered to user in certain instances during any operation, or potential operation, of the aerosol provision device. Particularly where these electrical feedback charges are delivered to a mouth of the user, these electrical charges can also be paired against particular flavours of aerosolisable material for improving and/or honing the user experience felt by the user whilst using these particular flavours, to enhance the sensations felt by the user through using these particular flavours of aerosolisable material.

### SUMMARY

According to a first aspect of certain embodiments there is provided an aerosol provision system for generating an aerosol; wherein the aerosol provision system comprises a feedback portion for outputting feedback to a user of the aerosol provision system, wherein the feedback comprises an electrical charge which is configured to be delivered to a portion of the aerosol provision system for transmission to the user of the aerosol provision system.

According to a second aspect of certain embodiments there is provided a mouthpiece for use in an aerosol provision system for generating an aerosol, wherein the mouthpiece comprises a feedback portion for outputting feedback to a user of the mouthpiece, wherein the feedback comprises an electrical charge which is configured to be delivered to a portion of the mouthpiece for transmission to the user of the mouthpiece.

According to a third aspect of certain embodiments there is provided a cartridge for an aerosol provision system comprising the cartridge and an aerosol provision device, wherein the cartridge comprises the mouthpiece according to the second aspect.

According to a fourth aspect of certain embodiments there is provided a method of delivering an electrical charge to a user of an aerosol provision system for generating an aerosol, wherein the method comprises:
in response to determining that a first predetermined criterion is satisfied, outputting feedback, comprising an electrical charge, from a feedback portion; and
delivering the electrical charge to a portion of the aerosol provision system, for transmitting the electrical charge to the user of the aerosol provision device via the portion of the aerosol provision system.

According to a fifth aspect of certain embodiments there is provided a method of delivering an electrical charge to a user of an aerosol provision system for providing electrical charge feedback to the user.

According to a sixth aspect of certain embodiments there is provided a method of delivering an aerosol of flavoured aerosolisable material to a mouth of a user of an aerosol generating system, wherein the method further comprises providing an electrical charge to the mouth of the user whilst the aerosol is being delivered to the mouth of the user.

It will be appreciated that features and aspects of the invention described above in relation to the various aspects of the invention are equally applicable to, and may be combined with, embodiments of the invention according to other aspects of the invention as appropriate, and not just in the specific combinations described herein.

### BRIEF DESCRIPTION OF THE DRAWINGS

Embodiments of the invention will now be described, by way of example only, with reference to the accompanying drawings, in which:

FIG. 1 schematically represents in perspective view an aerosol provision system comprising a cartridge and aerosol provision device (shown separated) in accordance with certain embodiments of the disclosure;

FIG. 2 schematically represents in exploded perspective view of components of the cartridge of the aerosol provision system of FIG. 1;

FIGS. 3A to 3C schematically represent various cross-section views of a housing part of the cartridge of the aerosol provision system of FIG. 1;

FIGS. 4A and 4B schematically represent a perspective view and a plan view of a dividing wall element of the cartridge of the aerosol provision system of FIG. 1;

FIGS. 5A to 5C schematically represent two perspective views and a plan view of a resilient plug of the cartridge of the aerosol provision system of FIG. 1;

FIGS. 6A and 6B schematically represent a perspective view and a plan view of a bottom cap of the cartridge of the aerosol provision system of FIG. 1;

FIG. 7 schematically represents embodiments of aerosol provision system, useable with an aerosol provision system such as that shown in FIGS. 1-6B, and comprising a feedback portion for outputting electrical charge feedback for transmission to a user of the aerosol provision system.

FIG. 8 schematically represents an embodiment of aerosol provision system, useable with an aerosol provision system such as that shown in FIGS. 1-6B, and comprising a feedback portion for outputting electrical charge feedback for transmission to a user of the aerosol provision system.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to non-combustible aerosol provision systems (such as an e-cigarette). According to the present disclosure, a “non-combustible” aerosol provision system is one where a constituent aerosolisable material of the aerosol provision system (or component thereof) is not combusted or burned in order to facilitate delivery to a user. Aerosolisable material, which also may be referred to herein as aerosol generating material or aerosol precursor material, is material that is capable of generating aerosol, for example when heated, irradiated or energized in any other way. The aerosolisable material may also be flavoured, in some embodiments.

Throughout the following description the term “e-cigarette” or “electronic cigarette” may sometimes be used, but it will be appreciated this term may be used interchangeably with an aerosol provision system. An electronic cigarette may also known as a vaping device or electronic nicotine delivery system (END), although it is noted that the presence of nicotine in the aerosolisable material is not a requirement.

In some embodiments, the aerosol provision system is a hybrid device configured to generate aerosol using a combination of aerosolisable materials, one or a plurality of which may be heated. In some embodiments, the hybrid device comprises a liquid or gel aerosolisable material and a solid aerosolisable material. The solid aerosolisable material may comprise, for example, tobacco or a non-tobacco product.

Typically, the (non-combustible) aerosol provision system may comprise a cartridge/consumable part and a body/reusable/aerosol provision device part, which is configured to releasably engage with the cartridge/consumable part.

The aerosol provision system may be provided with a means for powering a vaporiser therein, and there may be provided an aerosolisable material transport element for receiving the aerosolisable material that is to be vaporised. The aerosol provision system may also be provided with a reservoir for containing aerosolisable material, and in some embodiments a further reservoir for containing flavouring material for flavouring a generated vapour from the aerosol provision system.

In some embodiments, the vaporiser may be a heater/heating element capable of interacting with the aerosolisable material so as to release one or more volatiles from the aerosolisable material to form a vapour/aerosol. In some embodiments, the vaporiser is capable of generating an aerosol from the aerosolisable material without heating. For example, the vaporiser may be capable of generating a vapour/aerosol from the aerosolisable material without applying heat thereto, for example via one or more of vibrational, mechanical, pressurisation or electrostatic means.

In some embodiments, the substance to be delivered may be an aerosolisable material which may comprise an active constituent, a carrier constituent and optionally one or more other functional constituents.

The active constituent may comprise one or more physiologically and/or olfactory active constituents which are included in the aerosolisable material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, theine, a vitamin such as B6 or B12 or C, melatonin, a cannabinoid, or a constituent, derivative, or combinations thereof. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine, or mixtures thereof.

In some embodiments, the active constituent is an olfactory active constituent and may be selected from a “flavour” and/or “flavourant” which, where local regulations permit, may be used to create a desired taste, aroma or other somatosensorial sensation in a product for adult consumers. In some instances such constituents may be referred to as flavours, flavourants, flavouring material, cooling agents, heating agents, and/or sweetening agents. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavouring material (flavour) may comprise menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, colouring agents, preservatives, binders, fillers, stabilizers, and/or antioxidants.

As noted above, aerosol provision systems (e-cigarettes) may often comprise a modular assembly including both a reusable part (body—or aerosol provision device) and a replaceable consumable (cartridge) part. Devices conforming to this type of two-part modular configuration may generally be referred to as two-part devices. It is also common for electronic cigarettes to have a generally elongate shape. For the sake of providing a concrete example, certain embodiments of the disclosure described herein may comprise this kind of generally elongate two-part device employing consumable parts. However, it will be appreciated the underlying principles described herein may equally be adopted for other electronic cigarette configurations, for example modular devices comprising more than two parts, as devices conforming to other overall shapes, for example based on so-called box-mod high performance devices that typically have a more boxy shape.

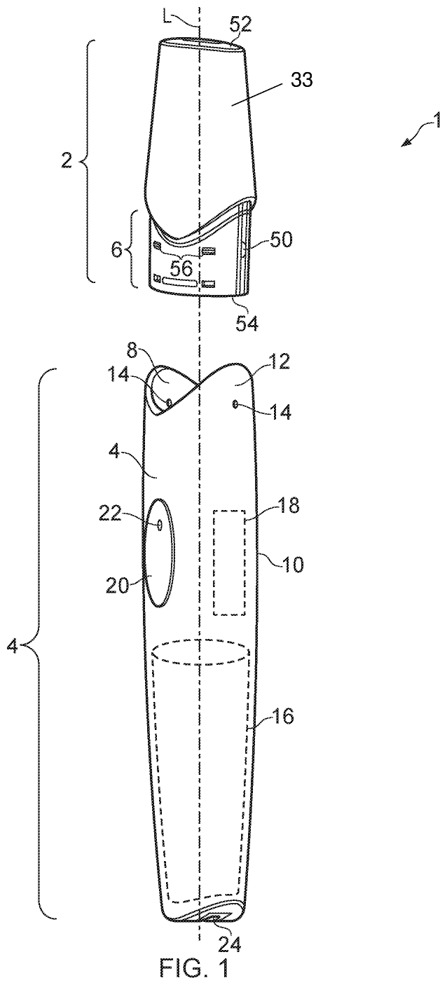

From the forgoing therefore, and with reference to FIG. 1 is a schematic perspective view of an example aerosol provision system (e-cigarette) 1 in accordance with certain embodiments of the disclosure. Terms concerning the relative location of various aspects of the electronic cigarette (e.g. terms such as upper, lower, above, below, top, bottom etc.) are used herein with reference to the orientation of the electronic cigarette as shown in FIG. 1 (unless the context indicates otherwise). However, it will be appreciated this is purely for ease of explanation and is not intended to indicate there is any required orientation for the electronic cigarette in use.

The e-cigarette 1 (aerosol provision system 1) comprises two main components, namely a cartridge 2 and an aerosol provision device 4. The aerosol provision device 4 and the cartridge 2 are shown separated in FIG. 1, but are coupled together when in use.

The cartridge 2 and aerosol provision device 4 are coupled by establishing a mechanical and electrical connection between them. The specific manner in which the mechanical and electrical connection is established is not of primary significance to the principles described herein and may be established in accordance with conventional techniques, for example based around a screw thread, bayonet, latched or friction-fit mechanical fixing with appropriately arranged electrical contacts/electrodes for establishing the electrical connection between the two parts as appropriate. For example electronic cigarette 1 represented in FIG. 1, the cartridge comprises a mouthpiece 33, a mouthpiece end 52 and an interface end 54 and is coupled to the aerosol provision device by inserting an interface end portion 6 at the interface end of the cartridge into a corresponding receptacle 8/receiving section of the aerosol provision device. The interface end portion 6 of the cartridge is a close fit to be receptacle 8 and includes protrusions 56 which engage with corresponding detents in the interior surface of a receptacle wall 12 defining the receptacle 8 to provide a releasable mechanical engagement between the cartridge and the aerosol provision device. An electrical connection is established between the aerosol provision device and the cartridge via a pair of electrical contacts on the bottom of the cartridge (not shown in FIG. 1) and corresponding sprung contact pins in the base of the receptacle 8 (not shown in FIG. 1). As noted above, the specific manner in which the electrical connection is established is not significant to the principles described herein, and indeed some implementations might not have an electrical connection between the cartridge and a aerosol provision device at all, for example because the transfer of electrical power from the reusable part to the cartridge may be wireless (e.g. based on electromagnetic induction techniques).

The electronic cigarette 1 (aerosol provision system) has a generally elongate shape extending along a longitudinal axis L. When the cartridge is coupled to the aerosol provision device, the overall length of the electronic cigarette in this example (along the longitudinal axis) is around 12.5 cm. The overall length of the aerosol provision device is around 9 cm and the overall length of the cartridge is around 5 cm (i.e. there is around 1.5 cm of overlap between the interface end portion 6 of the cartridge and the receptacle 8 of the aerosol provision device when they are coupled together). The electronic cigarette has a cross-section which is generally oval and which is largest around the middle of the electronic cigarette and tapers in a curved manner towards the ends. The cross-section around the middle of the electronic cigarette has a width of around 2.5 cm and a thickness of around 1.7 cm. The end of the cartridge has a width of around 2 cm and a thickness of around 0.6 mm, whereas the other end of the electronic cigarette has a width of around 2 cm and a thickness of around 1.2 cm. The outer housing of the electronic cigarette is in this example is formed from plastic. It will be appreciated the specific size and shape of the electronic cigarette and the material from which it is made is not of primary significance to the principles described herein and may be different in different implementations. That is to say, the principles described herein may equally be adopted for electronic cigarettes having different sizes, shapes and/or materials.

The aerosol provision device 4 may in accordance with certain embodiments of the disclosure be broadly conventional in terms of its functionality and general construction techniques. In the example of FIG. 1, the aerosol provision device 4 comprises a plastic outer housing 10 including the receptacle wall 12 that defines the receptacle 8 for receiving the end of the cartridge as noted above. The outer housing 10 of the aerosol provision device 4 in this example has a generally oval cross section conforming to the shape and size of the cartridge 2 at their interface to provide a smooth transition between the two parts. The receptacle 8 and the end portion 6 of the cartridge 2 are symmetric when rotated through 180° so the cartridge can be inserted into the aerosol provision device in two different orientations. The receptacle wall 12 includes two aerosol provision device air inlet openings 14 (i.e. holes in the wall). These openings 14 are positioned to align with an air inlet 50 for the cartridge when the cartridge is coupled to the aerosol provision device. A different one of the openings 14 aligns with the air inlet 50 of the cartridge in the different orientations. It will be appreciated some implementations may not have any degree of rotational symmetry such that the cartridge is couplable to the aerosol provision device in only one orientation while other implementations may have a higher degree of rotational symmetry such that the cartridge is couplable to the aerosol provision device in more orientations.

The aerosol provision device further comprises a battery 16 for providing operating power for the electronic cigarette, control circuitry 18 for controlling and monitoring the operation of the electronic cigarette, a user input button 20, an indicator light 22, and a charging port 24.

The battery 16 in this example is rechargeable and may be of a conventional type, for example of the kind normally used in electronic cigarettes and other applications requiring provision of relatively high currents over relatively short periods. The battery 16 may be recharged through the charging port 24, which may, for example, comprise a USB connector.

The input button 20 in this example is a conventional mechanical button, for example comprising a sprung mounted component which may be pressed by a user to establish an electrical contact in underlying circuitry. In this regard, the input button may be considered an input device for detecting user input, e.g. to trigger aerosol generation, and the specific manner in which the button is implemented is not significant. For example, other forms of mechanical button or touch-sensitive button (e.g. based on capacitive or optical sensing techniques) may be used in other implementations, or there may be no button and the device may rely on a puff detector for triggering aerosol generation.

The indicator light 22 is provided to give a user with a visual indication of various characteristics associated with the electronic cigarette, for example, an indication of an operating state (e.g. on/off/standby), and other characteristics, such as battery life or fault conditions. Different characteristics may, for example, be indicated through different colours and/or different flash sequences in accordance with generally conventional techniques.

The control circuitry 18 is suitably configured/programmed to control the operation of the electronic cigarette to provide conventional operating functions in line with the established techniques for controlling electronic cigarettes. The control circuitry (processor circuitry) 18 may be considered to logically comprise various sub-units/circuitry elements associated with different aspects of the electronic cigarette's operation. For example, depending on the functionality provided in different implementations, the control circuitry 18 may comprises power supply control circuitry for controlling the supply of power from the battery/power supply to the cartridge in response to user input, user programming circuitry for establishing configuration settings (e.g. user-defined power settings) in response to user input, as well as other functional units/circuitry associated functionality in accordance with the principles described herein and conventional operating aspects of electronic cigarettes, such as indicator light display driving circuitry and user input detection circuitry. It will be appreciated the functionality of the control circuitry 18 can be provided in various different ways, for example using one or more suitably programmed programmable computer(s) and/or one or more suitably configured application-specific integrated circuit(s)/circuitry/chip(s)/chipset(s) configured to provide the desired functionality.

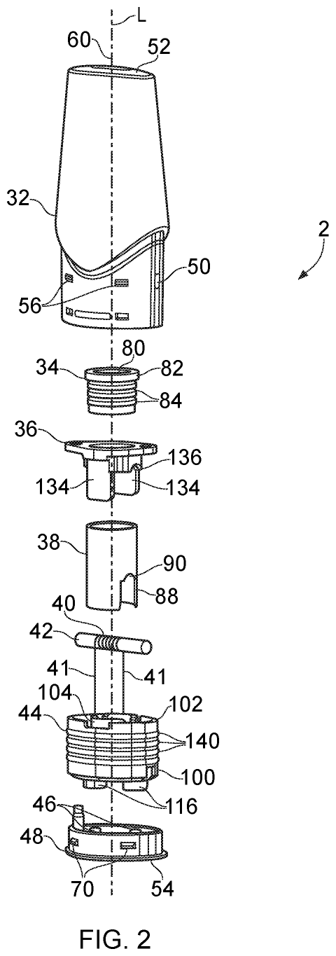

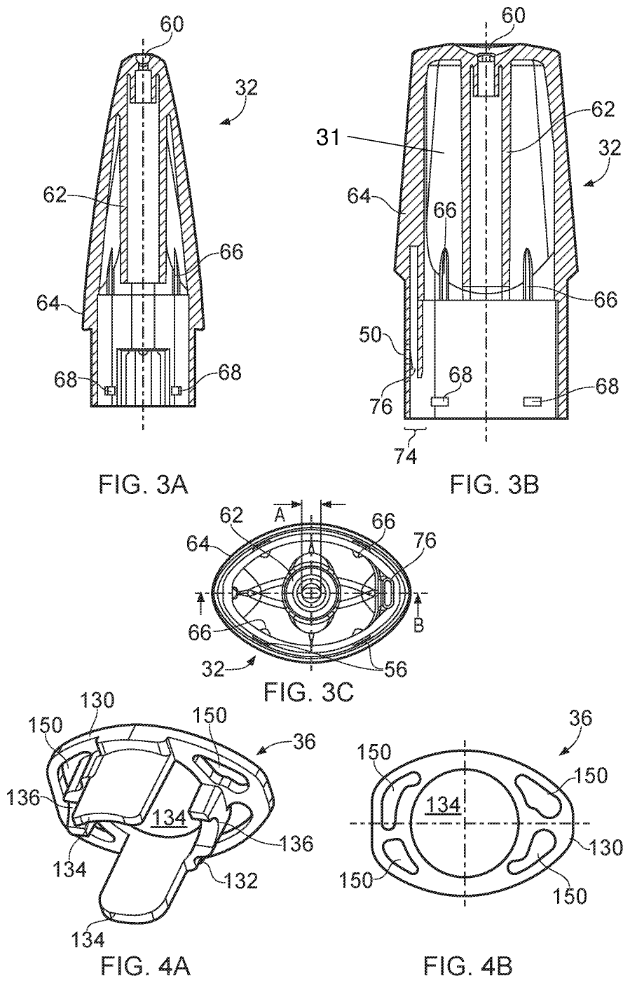

FIG. 2 is an exploded schematic perspective view of the cartridge 2 (exploded along the longitudinal axis L). The cartridge 2 comprises a housing part 32, an air channel seal 34, a dividing wall element 36, an outlet tube 38, a vaporiser/heating element 40, an aerosolisable material transport element 42, a plug 44, and an end cap 48 with contact electrodes 46. FIGS. 3 to 6 schematically represents some of these components in more detail.

FIG. 3A is a schematic cut-away view of the housing part 32 through the longitudinal axis L where the housing part 32 is thinnest. FIG. 3B is a schematic cut-away view of the housing part 32 through the longitudinal axis L where the housing part 32 is widest. FIG. 3C is a schematic view of the housing part along the longitudinal axis L from the interface end 54 (i.e. viewed from below in the orientation of FIGS. 3A and 3B).

FIG. 4A is a schematic perspective view of the dividing wall element 36 as seen from below. FIG. 4B is a schematic cross-section through an upper part of the dividing wall element 36 as viewed from below.

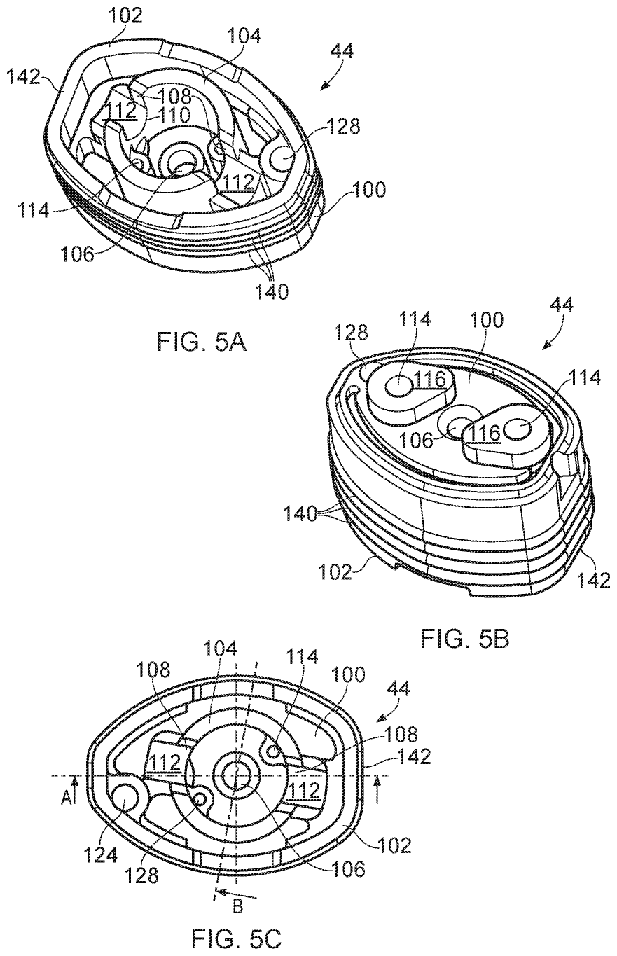

FIG. 5A is a schematic perspective view of the plug 44 from above and FIG. 5B is a schematic perspective view of the plug 44 from below. FIG. 5C is a schematic view of the plug 44 along the longitudinal axis L seen from the mouthpiece end 52 of the cartridge (i.e. viewed from above for the orientation in FIGS. 1 and 2).

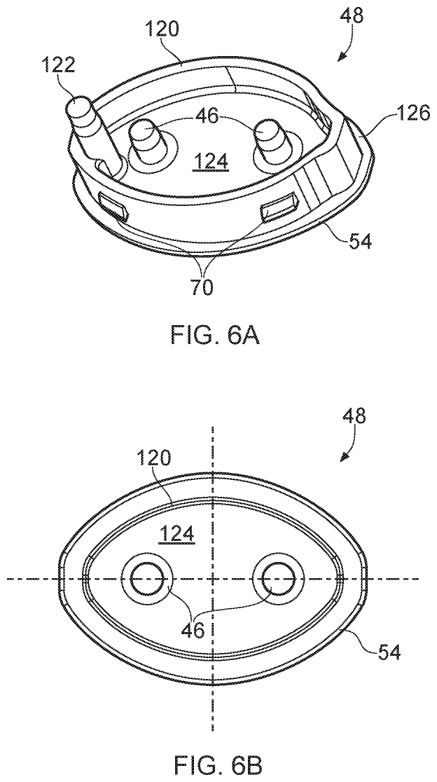

FIG. 6A is a schematic perspective view of the end cap 48 from above. FIG. 6B is a schematic view of the end cap 48 along the longitudinal axis L seen from the mouthpiece end 52 of the cartridge (i.e. from above).

The housing part 32 in this example comprises a housing outer wall 64 and a housing inner tube 62 which in this example are formed from a single moulding of polypropylene. The housing outer wall 64 defines the external appearance of the cartridge 2 and the housing inner tube 62 defines a part the air channel through the cartridge. The housing part is open at the interface end 54 of the cartridge and closed at the mouthpiece end 52 of the cartridge except for a mouthpiece opening/aerosol outlet 60, from the mouthpiece 33, which is in fluid communication with the housing inner tube 62. The housing part 32 includes an opening in a sidewall which provides the air inlet 50 for the cartridge. The air inlet 50 in this example has an area of around 2 mm². The outer surface of the outer wall 64 of the housing part 32 includes the protrusions 56 discussed above which engage with corresponding detents in the interior surface of the receptacle wall 12 defining the receptacle 8 to provide a releasable mechanical engagement between the cartridge and the aerosol provision device. The inner surface of the outer wall 64 of the housing part includes further protrusions 66 which act to provide an abutment stop for locating the dividing wall element 36 along the longitudinal axis L when the cartridge is assembled. The outer wall 64 of the housing part 32 further comprises holes which provide latch recesses 68 arranged to receive corresponding latch projections 70 in the end cap to fix the end cap to be housing part when the cartridge is assembled.

The outer wall 64 of the housing part 32 includes a double-walled section 74 that defines a gap 76 in fluid communication with the air inlet 50. The gap 76 provides a portion of the air channel through the cartridge. In this example the doubled-walled section 74 of the housing part 32 is arranged so the gap defines an air channel running within the housing outer wall 64 parallel to the longitudinal axis with a cross-section in a plane perpendicular to the longitudinal axis of around 3 mm². The gap/portion of air channel 76 defined by the double-walled section of the housing part extends down to the open end of the housing part 32.

The air channel seal 34 is a silicone moulding generally in the form of a tube having a through hole 80. The outer wall of the air channel seal 34 includes circumferential ridges 84 and an upper collar 82. The inner wall of the air channel seal 34 also includes circumferential ridges, but these are not visible in FIG. 2. When the cartridge is assembled the air channel seal 34 is mounted to the housing inner tube 62 with an end of the housing inner tube 62 extending partly into the through hole 80 of the air channel seal 34. The through hole 80 in the air channel seal has a diameter of around 5.8 mm in its relaxed state whereas the end of the housing inner tube 62 has a diameter of around 6.2 mm so that a seal is formed when the air channel seal 34 is stretched to accommodate the housing inner tube 62. This seal is facilitated by the ridges on the inner surface of the air channel seal 34.

The outlet tube 38 comprises a tubular section, for instance made of ANSI 304 stainless steel or polypropylene, with an internal diameter of around 8.6 mm and a wall thickness of around 0.2 mm. The bottom end of the outlet tube 38 includes a pair of diametrically opposing slots 88 with an end of each slot having a semi-circular recess 90. When the cartridge is assembled the outlet tube 38 mounts to the outer surface of the air channel seal 34. The outer diameter of the air channel seal is around 9.0 mm in its relaxed state so that a seal is formed when the air channel seal 34 is compressed to fit inside the outlet tube 38. This seal is facilitated by the ridges 84 on the outer surface of the air channel seal 34. The collar 80 on the air channel seal 34 provides a stop for the outlet tube 38.

The aerosolisable material transport element 42 comprises a capillary wick and the vaporiser (aerosol generator) 40 comprises a resistance wire heater wound around the capillary wick. In addition to the portion of the resistance wire wound around the capillary wick, the vaporiser comprises electrical leads 41 which pass through holes in the plug 44 to contact electrodes 46 mounted to the end cap 54 to allow power to be supplied to the vaporiser via the electrical interface the established when the cartridge is connected to a aerosol provision device. The vaporiser leads 41 may comprise the same material as the resistance wire wound around the capillary wick, or may comprise a different material (e.g. lower-resistance material) connected to the resistance wire wound around the capillary wick. In this example the heater coil 40 comprises a nickel iron alloy wire and the wick 42 comprises a glass fibre bundle. The vaporiser and aerosolisable material transport element may be provided in accordance with any conventional techniques and is may comprise different forms and/or different materials. For example, in some implementations the wick may comprise fibrous or solid a ceramic material and the heater may comprise a different alloy. In other examples the heater and wick may be combined, for example in the form of a porous and a resistive material. More generally, it will be appreciated the specific nature aerosolisable material transport element and vaporiser is not of primary significance to the principles described herein.

When the cartridge is assembled, the wick 42 is received in the semi-circular recesses 90 of the outlet tube 38 so that a central portion of the wick about which the heating coil is would is inside the outlet tube while end portions of the wick are outside the outlet tube 38.

The plug 44 in this example comprises a single moulding of silicone, may be resilient. The plug comprises a base part 100 with an outer wall 102 extending upwardly therefrom (i.e. towards the mouthpiece end of the cartridge). The plug further comprises an inner wall 104 extending upwardly from the base part 100 and surrounding a through hole 106 through the base part 100.

The outer wall 102 of the plug 44 conforms to an inner surface of the housing part 32 so that when the cartridge is assembled the plug in 44 forms a seal with the housing part 32. The inner wall 104 of the plug 44 conforms to an inner surface of the outlet tube 38 so that when the cartridge is assembled the plug 44 also forms a seal with the outlet tube 38. The inner wall 104 includes a pair of diametrically opposing slots 108 with the end of each slot having a semi-circular recess 110. Extended outwardly (i.e. in a direction away from the longitudinal axis of the cartridge) from the bottom of each slot in the inner wall 104 is a cradle section 112 shaped to receive a section of the aerosolisable material transport element 42 when the cartridge is assembled. The slots 108 and semi-circular recesses 110 provided by the inner wall of the plug 44 and the slots 88 and semi-circular recesses 90 of the outlet tube 38 are aligned so that the slots 88 in the outlet tube 38 accommodate respective ones of the cradles 112 with the respective semi-circular recesses in the outlet tube and plug cooperating to define holes through which the aerosolisable material transport element passes. The size of the holes provided by the semi-circular recesses through which the aerosolisable material transport element passes correspond closely to the size and shape of the aerosolisable material transport element, but are slightly smaller so a degree of compression is provided by the resilience of the plug 44. This allows aerosolisable material to be transported along the aerosolisable material transport element by capillary action while restricting the extent to which aerosolisable material which is not transported by capillary action can pass through the openings. As noted above, the plug 44 includes further openings 114 in the base part 100 through which the contact leads 41 for the vaporiser pass when the cartridge is assembled. The bottom of the base part of the plug includes spacers 116 which maintain an offset between the remaining surface of the bottom of the base part and the end cap 48. These spacers 116 include the openings 114 through which the electrical contact leads 41 for the vaporiser pass.

The end cap 48 comprises a polypropylene moulding with a pair of gold-plated copper electrode posts 46 mounted therein.

The ends of the electrode posts 44 on the bottom side of the end cap are close to flush with the interface end 54 of the cartridge provided by the end cap 48. These are the parts of the electrodes to which correspondingly aligned sprung contacts in the aerosol provision device 4 connect when the cartridge 2 is assembled and connected to the aerosol provision device 4. The ends of the electrode posts on the inside of the cartridge extend away from the end cap 48 and into the holes 114 in the plug 44 through which the contact leads 41 pass. The electrode posts are slightly oversized relative to the holes 114 and include a chamfer at their upper ends to facilitate insertion into the holes 114 in the plug where they are maintained in pressed contact with the contact leads for the vaporiser by virtue of the plug.

The end cap has a base section 124 and an upstanding wall 120 which conforms to the inner surface of the housing part 32. The upstanding wall 120 of the end cap 48 is inserted into the housing part 32 so the latch projections 70 engage with the latch recesses 68 in the housing part 32 to snap-fit the end cap 48 to the housing part when the cartridge is assembled. The top of the upstanding wall 120 of the end cap 48 abuts a peripheral part of the plug 44 and the lower face of the spacers 116 on the plug also abut the base section 124 of the plug so that when the end cap 48 is attached to the housing part it presses against the resilient part 44 to maintain it in slight compression.

The base portion 124 of the end cap 48 includes a peripheral lip 126 beyond the base of the upstanding wall 112 with a thickness which corresponds with the thickness of the outer wall of the housing part at the interface end of the cartridge. The end cap also includes an upstanding locating pin 122 which aligns with a corresponding locating hole 128 in the plug to help establish their relative location during assembly.

The dividing wall element 36 comprises a single moulding of polypropylene and includes a dividing wall 130 and a collar 132 formed by projections from the dividing wall 130 in the direction towards the interface end of the cartridge. The dividing wall element 36 has a central opening 134 through which the outlet tube 38 passes (i.e. the dividing wall is arranged around the outlet tube 38). In some embodiments, the dividing wall element 36 may be integrally formed with the outlet tube 38. When the cartridge is assembled, the upper surface of the outer wall 102 of the plug 44 engages with the lower surface of the dividing wall 130, and the upper surface of the dividing wall 130 in turn engages with the projections 66 on the inner surface of the outer wall 64 of the housing part 32. Thus, the dividing wall 130 prevents the plug from being pushed too far into the housing part 32—i.e. the dividing wall 130 is fixedly located along the longitudinal axis of the cartridge by the protrusions 66 in the housing part and so provides the plug with a fixed surface to push against. The collar 132 formed by projections from the dividing wall includes a first pair of opposing projections/tongues 134 which engage with corresponding recesses on an inner surface of the outer wall 102 of the plug 44. The protrusions from the dividing wall 130 further provide a pair of cradle sections 136 configured to engage with corresponding ones of the cradle sections 112 in the part 44 when the cartridge is assembled to further define the opening through which the aerosolisable material transport element passes.

When the cartridge 2 is assembled an air channel extending from the air inlet 50 to the aerosol outlet 60 through the cartridge is formed. Starting from the air inlet 50 in the side wall of the housing part 32, a first section of the air channel is provided by the gap 76 formed by the double-walled section 74 in the outer wall 64 of the housing part 32 and extends from the air inlet 50 towards the interface end 54 of the cartridge and past the plug 44. A second portion of the air channel is provided by the gap between the base of the plug 44 and the end cap 48. A third portion of the air channel is provided by the hole 106 through the plug 44. A fourth portion of the air channel is provided by the region within the inner wall 104 of the plug and the outlet tube around the vaporiser 40. This fourth portion of the air channel may also be referred to as an aerosol/aerosol generation region, it being the primary region in which aerosol is generated during use. The air channel from the air inlet 50 to the aerosol generation region may be referred to as an air inlet section of the air channel. A fifth portion of the air channel is provided by the remainder of the outlet tube 38. A sixth portion of the air channel is provided by the outer housing inner tube 62 which connects the air channel to the aerosol outlet 60, which is located at an end of the mouthpiece 33. The air channel from the aerosol generation region to be the aerosol outlet may be referred to as an aerosol outlet section of the air channel.

Also, when the cartridge is assembled a reservoir 31 for aerosolisable material is formed by the space outside the air channel and inside the housing part 32. This may be filled during manufacture, for example through a filling hole which is then sealed, or by other means. The specific nature of the aerosolisable material, for example in terms of its composition, is not of primary significance to the principles described herein, and in general any conventional aerosolisable material of the type normally used in electronic cigarettes may be used. The present disclosure may refer to a liquid as the aerosolisable material, which as mentioned above may be a conventional e-liquid. However, the principles of the present disclosure apply to any aerosolisable material which has the ability to flow, and may include a liquid, a gel, or a solid, where for a solid a plurality of solid particles may be considered to have the ability to flow when considered as a bulk.

The reservoir is closed at the interface end of the cartridge by the plug 44. The reservoir includes a first region above the dividing wall 130 and a second region below the dividing wall 130 within the space formed between the air channel and the outer wall of the plug. The aerosolisable material transport element (capillary wick) 42 passes through openings in the wall of the air channel provided by the semi-circular recesses 108, 90 in the plug 44 and the outlet tube 38 and the cradle sections 112, 136 in the plug 44 and the dividing wall element 36 that engage with one another as discussed above. Thus, the ends of the aerosolisable material transport element extend into the second region of the reservoir from which they draw aerosolisable material through the openings in the air channel to the vaporiser 40 for subsequent vaporisation.

In normal use, the cartridge 2 is coupled to the aerosol provision device 4 and the aerosol provision device activated to supply power to the cartridge via the contact electrodes 46 in the end cap 48. Power then passes through the connection leads 41 to the vaporiser 40. The vaporiser is thus electrically heated and so vaporises a portion of the aerosolisable material from the aerosolisable material transport element in the vicinity of the vaporiser. This generates aerosol in the aerosol generation region of the air path. Aerosolisable material that is vaporised from the aerosolisable material transport element is replaced by more aerosolisable material drawn from the reservoir by capillary action. While the vaporiser is activated, a user inhales on the mouthpiece end 52 of the cartridge. This causes air to be drawn through whichever aerosol provision device air inlet 14 aligns with the air inlet 50 of the cartridge (which will depend on the orientation in which the cartridge was inserted into the aerosol provision device receptacle 8). Air then enters the cartridge through the air inlet 50, passes along the gap 76 in the double-walled section 74 of the housing part 32, passes between the plug 44 and the end cap 48 before entering the aerosol generation region surrounding the vaporiser 40 through the hole 106 in the base part 100 of the plug 44. The incoming air mixes with aerosol generated from the vaporiser to form a condensation aerosol, which is then drawn along the outlet tube 38 and the housing part inner 62 before exiting through the mouthpiece outlet/aerosol outlet 60 for user inhalation.

From the above FIGS. 1-6B, it can be seen a possible embodiment construction of aerosol provision system 1 which is configured for generating an aerosol, which is suitable for use in the context of the present disclosure (alongside potentially other forms of aerosol provision system).

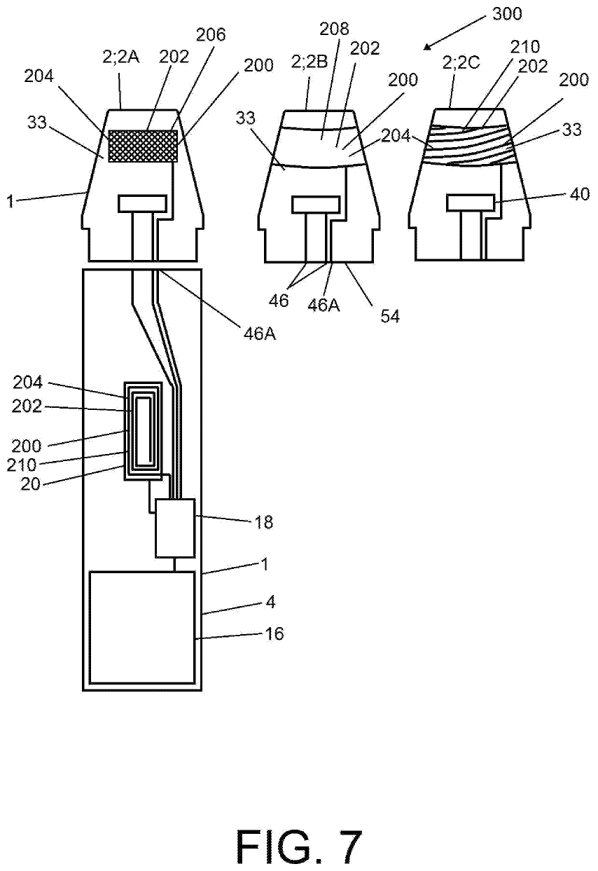

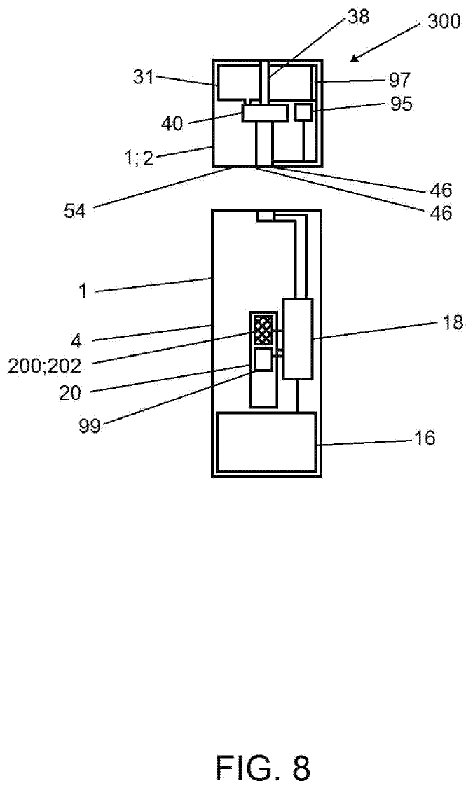

Turning now to FIGS. 7-8, the present disclosure also provides for an aerosol provision system 300 comprising a feedback portion 200, such as an electrical charge feedback portion, for outputting feedback, specifically electrical charge feedback, to a user of the (or an existing) aerosol provision system 1. As will be described in more detail below, it is envisaged that the delivery of the electrical charge feedback to the user might be used for a variety of purposes, such as feedback intended to either provide a user with an indication of an operation or a characteristic relating to the aerosol provision system 1 (or relating to a cartridge/consumable 2 or aerosol provision device 4 which may be employed in some embodiments of the aerosol provision system 1). As well, the feedback can also be used to enhance the sensations felt by the user through using particular different flavours of aerosolisable material (where such different flavours of aerosolisable material are employed).

Appreciating the foregoing therefore, in so far as any feedback is configured to be outputted by the feedback portion 200, the feedback may comprise an electrical charge which is configured to be delivered to a portion 202 of the aerosol provision system 1 for transmission to the user of the aerosol provision system 1. By transmission here, this may be interpreted to mean that the electrical charge is configured to be delivered to the user themselves, such that the user may feel a sensation, such as a tingling or shocking sensation in accordance with some embodiments, when the electrical charge is transmitted to them.

In accordance with some embodiments, the electrical charge feedback may be configured to be delivered to a portion of the user, such as their hand whilst they are gripping the aerosol provision system 1. In this way, the user may feel the feedback in their hand when the feedback is transmitted to them.

Equally however, and in accordance with some embodiments, the feedback may be configured to be delivered to a mouth of the user, such as their lips; their tongue; and/or an inner side, or the roof, of the user's mouth. In this way therefore, the user may feel the feedback in/around their mouth area when the electrical charge feedback is transmitted to them.

Placing the above in context therefore, and depending on the intended application of the electrical charge feedback, in accordance with some embodiments, the portion 202 of the aerosol provision system 1 (to which the electrical charge is configured to be delivered by the feedback) may comprise an external surface 204 of the aerosol provision system 1, such to better allow for the electrical charge to transmitted to the user of the aerosol provision system 1.

In accordance with some embodiments, such as those above where the feedback may be configured to be delivered to a hand of the user, in some of these embodiments, any provided user input actuator for controlling an operation of the aerosol provision device, such as the user input button 20, may conveniently be configured to comprise the portion 202 to which the electrical charge is configured to be delivered by the feedback. In this way, when the user is operating the device, in so far as they may then simply rest a portion of their hand over this user input actuator, the user may then easily feel any of the feedback delivered thereto.

Equally, in accordance with some narrower embodiments where the feedback is configured to be delivered to the user's mouth area, any provided mouthpiece 33 from the aerosol provision system 1 may comprise the portion 202 to which the electrical charge is configured to be delivered to. With respect to such embodiments as well, it may also be appreciated that the electrical charge may be configured to be delivered in response to the user using an actuator/user input button 20 which is located on the mouthpiece 33. In this way, the aerosol provision system may be able to be mouth actuated, such as via using a user's lip or tongue. Put differently, in such embodiments the electrical charge may be configured to be delivered effectively on-demand by the user (by the user appropriately using the actuator located on the mouthpiece 33).

More generally speaking however, and in embodiments where the aerosol provision system 1 comprises a cartridge 2 and an aerosol provision device 4, it will be appreciated that in such embodiments, the electrical charge may be configured to be delivered to either a portion 202 of the cartridge 2, and/or a portion 202 of the aerosol provision device 4, as required.

With regards to the composition and structure of the feedback portion 200, it will be appreciated that the feedback portion 200 may be configured to receive power from a power source in the aerosol provision device/system, such as any provided power source in the aerosol provision system 1 (such as the battery 16). Equally, in accordance with some embodiments, any operation of the feedback portion 200 maybe configured to be controlled by the aerosol provision device/system, such as via the control circuitry 18. In this way therefore, in accordance with such embodiments, such as that shown in the embodiments of FIGS. 7 and 8, the feedback portion 200 may be electrically connected to the power source (e.g. the battery 16) and/or the control circuitry 18 from the aerosol provision system 1.

In terms of the intended functions of the electrical charge feedback which is configured to be output by the feedback portion 200, it is envisaged that the feedback may be used to provide a number of different indications, and be used for a variety of different purposes. Generally speaking however, in accordance with some embodiments, the feedback portion 200 may be configured to output the feedback in response to a first predetermined criterion being satisfied.

Depending on the aerosol provision system 300 employed, it will be appreciated that the predetermined criterion could be a variety of different criterion.

In this respect for instance, in accordance with some embodiments, such as those embodiments where the feedback is intended to be used for enhancing the flavour of a flavoured aerosolisable material, the predetermined criterion may comprise the cartridge 2 being received by the aerosol provision device 4, and the aerosol provision system 1 (such as the vaporiser 40 from the aerosol provision system 1) being operated for generating the aerosol using the first cartridge 2. In this way for instance, when the aerosol is generated, the feedback portion 200 may be configured to output appropriate electrical charge feedback to the user of the aerosol provision system 1, e.g. to their mouth via the mouthpiece 33.

Appreciably however, where the predetermined criterion comprises the cartridge 2 being received by the aerosol provision device 4, and the aerosol provision system 1 being operated for generating the aerosol using the first cartridge 2, this predetermined criterion may also be used for providing electrical charge feedback to the user of the aerosol provision device for indicating that the aerosol provision device is being operated. This may be particularly helpful for those users with a visual impairment, who may be otherwise less able to discern when the aerosol provision system 1 is being operated.

Mindful of the above described embodiments therefore, and in accordance with more sophisticated embodiments of aerosol provision system 300, the feedback may comprise first feedback; with the feedback portion 200 being further configured for outputting second feedback to a user of the aerosol provision device, wherein the second feedback is different from the first feedback. In this way, the second feedback may comprise a second electrical charge which is configured to be delivered to the portion 202 of the aerosol provision system 1 for transmission to the user of the aerosol provision system 1. In this way, the feedback portion 20 may be configured to output the second feedback in response to a second predetermined criterion being satisfied, wherein the second predetermined criterion is different from the first predetermined criterion. In accordance with such embodiments therefore, by being able to (separately) output either a first or second electrical charge feedback in response to either a first or a second predetermined criterion being satisfied, the feedback portion 200 may be configured to react to different events occurring in the aerosol provision system 300 at any given time(s).

For instance, in accordance with some embodiments, in so far as the aerosol provision system 1 may comprise an aerosol provision device 4 which is configured to receive a second cartridge 2B (or even third cartridge 2C), which is different from the first cartridge 2A (e.g. in so far as the first cartridge 2A comprises a reservoir 31 of a different volumetric capacity of aerosolisable material; a different amount of aerosolisable material; and/or a different flavour of aerosolisable material, to that of the second cartridge 2B [or third cartridge 2C]), the second predetermined criterion may comprise the aerosol provision device 4 receiving the second cartridge 2B, and the aerosol provision system 1 being operated for generating the aerosol using the second cartridge 2B. In this way for instance, in so far as the second electrical charge feedback may be different from the first second electrical charge feedback (e.g. delivered at a different maximum current, or at a different maximum voltage, or output for a different duration of time), the output of the feedback portion 200, and the electrical charge feedback which is transmitted to (and thus felt by) the user, may be used by the user to discern which type of cartridge 2A; 2B; 2C is being operated and/or which type of cartridge 2 is connected to the aerosol provision device 4.

The above notwithstanding, the above embodiments may also be used by the aerosol provision system 300 to match different electrical charge feedback to different flavours of aerosolisable material which is to be vaporised, to enhance the perceived flavour when the aerosolisable material is delivered to the user's mouth. In this respect therefore, in so far as the first cartridge 2A comprises an aerosolisable material comprising a first flavour or composition, and the second cartridge 2B comprises an aerosolisable material comprising a second flavour or composition which is different from the first flavour, the aerosol provision system 300 may be configured to output different first and second electrical charge feedback, such to better tailor the first and second feedback to the respective first and second flavours. This is so, not least due to the realisation that electrical charges delivered to a user (such as to their mouth, e.g. their lips or their tongue) experiencing a flavour of aerosolisable material can positively affect the user's perceived experience of that flavour, specifically in so far as a small electrical charge delivered to the user whilst they are inhaling this aerosol can enhance the perceived flavour by the user as they are inhaling the vapour in their mouth.

With respect to any such electrical charge feedback used in this way, the electrical charge feedback may be best felt by the user for enhancing the flavour of the aerosolisable material through the feedback being delivered to the user's mouth area. To facilitate this therefore, in accordance with some embodiments, the feedback portion 200 may be located on or in the mouthpiece 33, such as on an external surface 204 thereof. In this way, when the user places their mouth over the mouthpiece 33, the user's mouth area may contact the feedback portion 200 to allow the electrical charge feedback to be transmitted to the user.

As to the shape/structure of the feedback portion 200, it will be appreciated that this may vary depending on the intended function of the feedback which the feedback portion 200 is configured to output, and may also depend on where the feedback portion 200 is located on the aerosol provision system 1. Appreciably however, in accordance with some embodiments, the feedback portion 200 may comprise an electrically conductive component located at the portion 202 of the aerosol provision system 1. For instance, and as shown in the embodiments illustrated in FIG. 7, the feedback portion 200 may in some embodiments comprise a mesh shaped component 206 located at the portion 202 of the aerosol provision device, a sheet or plate 208 of electrically conductive material located at the portion 202 of the aerosol provision device, and/or a coil of wire 210 located at the portion 202 of the aerosol provision system 1.

Thus with reference to the embodiments described above, it will be appreciated potential applications for the feedback portion 200 include it being useable for outputting electrical charge feedback to provide an indication to the user when a particular cartridge type, or flavour of aerosolisable material, is being delivered to the user. This feedback can also be used to enhance the flavour of any flavoured aerosolisable material which is delivered to the user.

It is envisaged that another application of the electrical charge feedback is to better prevent the operation of the aerosol provision system 1 when a given use thereof is unauthorised. By way of an unauthorised use, this may be interpreted as covering uses when the device is not intended to be used by the user. For instance, in accordance with some embodiments, the unauthorised use may comprise a use when any vaporiser 40 from the aerosol provision system 1 is determined as having overheated (noting use of the aerosol provision system 1 in these instances could cause injury to the user). Equally, in accordance with some additional/alternative embodiments, the unauthorised use may comprise a use when the aerosol provision system 1 is determined as comprising less than a predetermined amount of aerosolisable material (which could be indicative of ‘dry out’ conditions in the aerosol provision system 1 through there not being enough aerosolisable material left in the system 1 for vaporising by the vaporiser 40 to keep any aerosolisable material transport element 42 suitably wet/moist with aerosolisable material).

Equally, in accordance with some additional/alternative embodiments, an unauthorised use could comprise a use by a user that is not determined as being an authorised user of the aerosol provision system 1.

Appreciating the forgoing therefore, it may be appreciated that in accordance with some embodiments, the first predetermined criterion (or any second or additional/other predetermined criterion, which may be present, beyond any provided first predetermined criterion) may comprise a positive determination of an unauthorised use of the aerosol provision device.

Whatever the predetermined criterion which may be used by the aerosol provision system, it will be appreciated that the aerosol provision system may be configured to signal the feedback portion as to when to output the feedback, in response to determining that the first predetermined criterion is satisfied. In this way for instance, with respect to any provided predetermined criterion(s), the aerosol provision system may be configured to generate a (first/second/third/nth) signal, in response to determining that the (first/second/third/nth) predetermined criterion is satisfied, and send the first (or second/third/nth) signal to the feedback portion. In this way, the feedback portion 200 may be configured to output the feedback in response to the feedback portion 200 receiving the first (or second/third/nth) signal.

In so far as any given first (second/third/nth) signal(s) may be generated in the aerosol provision system 300, as noted above, it will be appreciated that each such signal may be generated in an appropriate way, depending on the predetermined criterion which is associated with the signal. In accordance with some particularly convenient embodiments, where the aerosol provision system 1 comprises the control circuitry 18, the control circuitry 18 may be configured for determining whether the predetermined criterion is satisfied, and/or may be configured to generate the relevant signal in the event that this predetermined criterion is satisfied.

Equally, to facilitate any determination of a given predetermined criterion being satisfied, the control circuitry 18 in accordance with some embodiments (e.g. as per the illustrated embodiment from FIG. 8) may be configured to receive sensor data from the aerosol provision system 1, and be configured to process the sensor data to determine whether the predetermined criterion is satisfied. For instance, in embodiments where the predetermined criterion comprises the vaporiser 40 exceeding a predetermined temperature (e.g. as part of the predetermined criterion comprising a determination of an unauthorised use of the aerosol provision system 1), the control circuitry 18 may be configured to receive sensor data from a temperature sensor 95 from the aerosol provision system 1.

Equally, where the predetermined criterion comprises there being less than a predetermined amount of aerosolisable material, e.g. in the reservoir 31 or in the aerosol provision system 1, the control circuitry 18 in accordance with some embodiments (e.g. as per the illustrated embodiment from FIG. 8) may be configured to receive sensor data from a sensor 97 from the aerosol provision system 1 (such as a capacitive sensor, or some other fluid-level detecting sensor) which is configured to output sensor data indicative of the amount of remaining aerosolisable material.

Appreciably as well, where the predetermined criterion comprises the determination of a use by a user that is not determined as an authorised user of the aerosol provision system 1, the control circuitry 18 may be configured to receive sensor data from a sensor 99 from the aerosol provision system 1 (such as a fingerprint sensor) which is configured to output sensor data for indicating the identity of a user of the aerosol provision system 1. Appreciably, in accordance with some particular embodiments, the sensor 99 may be located on, or as part of, the user input button 20, as illustrated in the embodiment of FIG. 8 for instance.

Equally, and as necessary, where any control circuitry 18 is employed for determining when the aerosol provision system 1 is being operated for generating an aerosol, the control circuitry 18 may be in electrical communication with the power source (such as the battery 16) and/or the input button 20 to facilitate making a determination that the aerosol provision system 1 is being operated. Equally, and in so far as the aerosol provision device/system may be configured to make a determination as to the which type of cartridge 4 is received by the aerosol provision device 4 (e.g. either the first cartridge 2A or the second cartridge 2B), it will be appreciated that in accordance with some embodiments, the control circuitry 18 may be configured to determine the type of cartridge (i.e. whether this be the first cartridge 2A or the second cartridge 2B) which is received by the aerosol provision device 4. This may, in practice, appreciably be achieved in a number of ways, e.g. by way of receiving cartridge data which can be transmitted to the control circuitry 18 via the contact electrodes 46; 46A when the cartridge 2 is received by the aerosol provision device 4.

Appreciating the above therefore, it may be seen that the herein described feedback portion 200 may be used to output feedback, such as electrical charge feedback, to a user of the aerosol provision system 1, wherein the feedback comprises an electrical charge which is configured to be delivered to a portion 202 of the aerosol provision system 1 for transmission to the user of the aerosol provision system 1.

In accordance with some embodiments, the feedback portion 200 may be configured to deliver the charge to the portion 202 of the aerosol provision system 1 at a maximum voltage of any of: no more than 50V (volts); no more than 40V; no more than 30V; no more than 20V; no more than 15V; no more than 10V; no more than 8V; no more than 6V; no more than 5V; and/or no more than 4V. Equally, in accordance with some additional/alternative embodiments, the feedback portion 200 may configured to deliver the charge to the portion at a maximum voltage of any of at least 0.5V; at least 1V, at least 1.5V; and/or at least 2V. This being the case, the feedback portion may equally be configured to deliver the charge to the portion 202 at a maximum voltage which is in a range between any combination of the above recited maximum voltages, such as greater than 0.5V and no more than 50V.

Equally, and in accordance with some embodiments, the feedback portion 200 may be configured to deliver the charge to the portion 202 at a maximum current of any of no more than 5 mA (milliAmps); no more than 2.5 mA; no more than 1 mA; no more than 750 μA; no more than 500 μA; no more than 400 μA; no more than 300 μA; no more than 200 μA; no more than 150 μA; no more than 100 μA; and/or no more than 50 μA. Equally, in accordance with some additional/alternative embodiments, the feedback portion may configured to deliver the charge to the portion 202 at a maximum current of any of at least 10 μA; at least 20 μA; at least 30 μA, at least 40 μA; at least 50 μA; at least 100 μA; at least 150 μA; at least 200 μA; at least 250 μA; at least 300 μA; at least 400 μA; at least 500 μA; at least 750 μA; at least 1 mA; and/or at least 2.5 mA. This being the case, the feedback portion may be configured to deliver the charge to the portion at a maximum current which is in a range between any combination of the above recited maximum currents, such as at least 10 μA and no more than 5 mA.

With respect to these delivered maximum voltages and currents however, it will be appreciated that the delivered maximum voltage and current may be higher in embodiments where the feedback is configured to be output in response to an unauthorised use of the aerosol provision system 1 being determined (e.g. to better/more sharply feedback to the user that the aerosol provision system 1 should not be used in these instances, and/or to better prevent the user being injured through use in these instances when the aerosol provision system 1 may have otherwise malfunctioned, e.g. overheated). In accordance with such embodiments for instance, the electrical charge may be relatively more strong, and may in accordance with some particular embodiments therefore comprise a maximum voltage of no more than 50V, and/or may comprise a maximum current of no more than 5 mA.

This contrasts with instances, in accordance with some embodiments, where the feedback may be configured to be output during operation of the aerosol provision system 1 whilst a cartridge 2, such as a cartridge 2 of a particular type and/or containing a particular flavour of aerosolisable material, is received by the aerosol provision device 4, where the feedback may be used for either indicating the type of cartridge connected, and/or to complement/enhance the flavour of aerosolisable material used in that particular cartridge 2. Thus in accordance with these latter embodiments, the electrical charge feedback may be more mild, and may in accordance with some particular embodiments comprise a maximum voltage of no more than 10V, and/or may comprise a current of at least 10 μA and no more than 500 μA.

With respect to the duration in which the feedback portion 200 may be configured to output the feedback, it will be appreciated that this may be variable depending on the intended application of the feedback.

For instance, in accordance with some embodiments, such as potentially those where the electrical charge feedback is configured to be output in response to an unauthorised use of the aerosol provision device 200 being determined, or for use in indicating the type of cartridge 2 which is connected to any provided aerosol provision device 4 from the aerosol provision system 1 (where such a cartridge 2/aerosol provision device 4 arrangement is employed), the feedback portion 200 may be configured to output the feedback, potentially either intermittently or continuously, for a predetermined duration, such as a short duration of no more than 5 seconds, 3 seconds or a second, such to provide the user with a sufficiently short duration of feedback to allow the feedback to be discerned by the user, yet in a way which does not unduly drain the power from the power source of the aerosol provision system 1 through the feedback being provided for an undue amount of time.

Appreciably as well, in accordance with some embodiments, the feedback portion 200 may be configured to output the feedback, potentially either intermittently or continuously, for a predetermined duration, wherein the feedback portion 200 is configured to decrease the predetermined duration as the electrical current, or electrical power, of the feedback is increased. In this way, and in so far as the feedback portion 200 may be configured to output feedback at different current, or power, levels, the feedback portion 200 may be configured to reduce the predetermined duration to cater for higher current or power levels (to avoid supplying the user with too much feedback in a given feedback session).

Equally, in accordance with some other embodiments, such as potentially those where the feedback is intended to be used more subtly for enhancing the flavour of an particular aerosolisable material which is being vaporised during the operation of the aerosol provision system 1, the feedback portion 200 may be configured to continuously output the feedback to the user of the aerosol provision device whilst the aerosol provision device is being operated (or whilst the vaporiser 40 from the aerosol provision system 1 is being operated) for generating the aerosol. In this way, the flavour enhancing feedback may be used to ensure that the flavour of the aerosolisable material is continually being enhanced whilst the aerosol provision system 1 (or whilst the vaporiser 40 of the aerosol provision system 1) is being operated for generating the aerosol.

It should also be appreciated that in some embodiments the electrical charge feedback may be selectively provided to the user depending on certain criteria. For example, the user may be able to manually turn on and off the provision of the electrical charge feedback (e.g., using a button or other actuator on the aerosol provision device, or via a remote source such as a smartphone or the like communicatively coupled to the aerosol provision device). Additionally or alternatively, the electrical charge feedback may be selectively activated upon the intended user successfully completing a medical assessment or questionnaire presented on a display of the aerosol provision device or through an app communicatively coupled to the aerosol provision device. For example, the user may be required to state whether they have a pacemaker or similar electronic device or any pre-existing medical conditions that may be incompatible with or unadvisable with delivery of electrical charge feedback.

With reference to the foregoing disclosure therefore, there has accordingly been described a number of different possible implementations for a feedback portion 200 for use in an aerosol provision system 300. The feedback portion 200 may be supplied with a given aerosol provision system 1, or part thereof such as a cartridge 2 or mouthpiece 33 therefrom. The feedback portion 200 may be used in a number of different ways to provide electrical charge feedback to the user. Such electrical charge feedback could be output, for instance, in response to an unauthorised use of the aerosol provision device being determined, or for use in indicating the type of cartridge 2 which is connected to any provided aerosol provision device 4 from the aerosol provision system 1 (where such a cartridge 2/aerosol provision device 4 arrangement is employed), or used to enhance the flavour of any particular type of flavoured aerosolisable material which is delivered to the user when the aerosol provision system 1, or the vaporiser 40 from the aerosol provision system 1, is being operated for generating an aerosol.

Appreciating the foregoing therefore, there has accordingly been described an aerosol provision system for generating an aerosol; wherein the aerosol provision system comprises a feedback portion for outputting feedback to a user of the aerosol provision system, wherein the feedback comprises an electrical charge which is configured to be delivered to a portion of the aerosol provision system for transmission to the user of the aerosol provision system.

There has also been described a mouthpiece for use in an aerosol provision system for generating an aerosol, wherein the mouthpiece comprises a feedback portion for outputting feedback to a user of the mouthpiece, wherein the feedback comprises an electrical charge which is configured to be delivered to a portion of the mouthpiece for transmission to the user of the mouthpiece.

There has also been described a cartridge for an aerosol provision system comprising the cartridge and an aerosol provision device, wherein the cartridge comprises the mouthpiece as described above.

There has also been described a method of delivering an electrical charge to a user of an aerosol provision system for generating an aerosol, wherein the method comprises:
in response to determining that a first predetermined criterion is satisfied, outputting feedback, comprising an electrical charge, from a feedback portion; and
delivering the electrical charge to a portion of the aerosol provision system, for transmitting the electrical charge to the user of the aerosol provision device via the portion of the aerosol provision system.

There has also been described a method of delivering an electrical charge to a user of an aerosol provision system for providing electrical charge feedback to the user.

There has also been described a method of delivering an aerosol of flavoured aerosolisable material to a mouth of a user of an aerosol generating system, wherein the method further comprises providing an electrical charge to the mouth of the user whilst the aerosol is being delivered to the mouth of the user.

There has also been described a feedback portion 200 for use in an aerosol provision system 300. The feedback portion 200 may be supplied with a given aerosol provision system 1, or part thereof such as a cartridge 2 or mouthpiece 33. The feedback portion 200 may be configured to output electrical charge feedback, to a user of the aerosol provision system, in response to a predetermined criterion being satisfied. The feedback portion 200 may also be configured to output electrical charge feedback to enhance the flavour of any particular type of flavoured aerosolisable material which is configured to be delivered to the user when the aerosol provision device is being operated for generating an aerosol.

Examples below are also provided, to provide further illustrations as to how the feedback portion 200 described herein may be operated.

### Example 1

An aerosol provision system 1 is provided which contains an aerosolisable material comprising a sour flavouring, such as lime or lemon flavouring.

The aerosolisable material, comprising the flavouring, is then delivered as an aerosol, via the mouthpiece 33 of the aerosol provision system 1 to a number of users separately. The mouthpiece 33 comprises the feedback portion 200 for outputting electrical charge feedback to the user's mouth and tongue area when the user operates the aerosol provision system 1 to receive the sour flavoured aerosol of aerosolisable material.

At the same time as the aerosol is delivered into the user's mouth, an additional electrical charge is supplied to the mouthpiece 33 of the aerosol provision system 1, via the feedback portion 200. The maximum current of the electrical charge feedback is varied in different operations of the aerosol provision system 1, and is varied between a maximum current of at least 10 μA, and no more than 500 μA. The maximum voltage supplied is around 3 Volts.

Whilst the aerosol provision system 1 is operated for generating the sour flavoured aerosol, the electrical charge feedback is continuously supplied for the duration of the operation.

Through the addition of this electrical charge, this is found by a number of the users to improve the sourness of the aerosol, without the need for a stronger concentration of the sour flavouring in the aerosolisable material to otherwise improve this sourness.

### Example 2

An aerosol provision system 1 is provided which contains an aerosolisable material comprising a bitter, coffee, flavouring.

The aerosolisable material, comprising the coffee flavouring, is then delivered as an aerosol, via the mouthpiece 33 of the aerosol provision system 1 to a number of users separately. The mouthpiece comprises the feedback portion 200 for outputting electrical charge feedback to the user's mouth and tongue area when the user operates the aerosol provision device to receive the sour flavoured aerosol of aerosolisable material.

At the same time as the aerosol is delivered into the user's mouth, an additional electrical charge is supplied to the mouthpiece 33 of the aerosol provision system 1, via the feedback portion 200. The maximum current of the electrical charge feedback is varied in different operations of the aerosol provision system 1, and is varied between a maximum current of between at least 15 μA, and no more than 300 μA. The maximum voltage supplied is no more than 5 Volts.

Whilst the aerosol provision system 1 is operated for generating the bitter flavoured aerosol, the electrical charge feedback is continuously supplied for the duration of the operation.

Through the addition of this electrical charge, this is found by a number of the users to enhance the bitterness of the coffee flavoured aerosol, without the need for a stronger concentration of coffee flavouring in the aerosolisable material to otherwise enhance the bitterness felt by the user in the delivered aerosol.

### Example 3

An aerosol provision system 1 is provided which contains an aerosolisable material for vaporising, and a temperature sensor 95 for outputting sensor data which is configured for use by control circuitry 18 of the aerosol provision system 1 to determine whether a vaporiser 40 from the aerosol provision system 1 exceeds a predetermined temperature (which is indicative of the vaporiser 40 as having overheated).

The aerosolisable material is then delivered as an aerosol to a number of users separately.

The aerosol provision system 1 comprises the feedback portion 200, which is located on a body portion of the aerosol provision system 1 for outputting electrical charge feedback to the user's hand (as they grip the aerosol provision system 1) when the control circuitry 18 determines that the vaporiser 40 has exceeded the predetermined temperature.

In these cases, the feedback portion 200 is configured to output the feedback continuously for no more than 1 second, and at a maximum current of between 500 μA and 5 mA.

Through the addition of this electrical charge feedback to the user's hand, this is found by a number of the users to provide a quick and convenient indication that the system 1 should not be further used in these instances, compared with if the electrical charge feedback is not otherwise output to the user. The electrical charge feedback in these unauthorised use instances is found to reduce the likelihood of the system 1 being further used, which might otherwise risk heat damage to the aerosol provision system 1, and/or injury to the user.

### END OF EXAMPLES

From the above Examples 1-3, it can therefore be seen that the herein described feedback portion 200 for outputting electrical charge feedback can be used in a number of different beneficial ways to improve the operation of an aerosol provision system 1, such as those described herein.

In this respect therefore, in order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

For instance, in terms of how any of the sensor(s) or feedback portion 200 may be powered (if they are present at all), it will be appreciated that these features may be powered using either the power supply 16 (as shown in the embodiment of FIG. 7 or 8), or each powered with its own power source (not shown in the Figures).

Equally, with regard to the positioning of any such sensor(s) and/or the feedback portion 200, it will be appreciated that their locations may be provided anywhere in the aerosol provision system 300 as may be required to allow them to provide their required functionality. In the case of the feedback portion 200, this may even include a location where the feedback portion 200 is not actually located on the aerosol provision system 1 (e.g. in a separate device which is attachable to the user, such as a strap or some other patch or device which may be secured (releasably if needs be, e.g. via an adhesive patch, to the user).

Equally, and where the aerosol provision system 1 comprises a cartridge 2 and an aerosol provision device 4, any provided sensor(s) may be located in either the cartridge 2 or the aerosol provision device 4, as needed so as to allow the required functionality of the sensor.

For the sake of completeness as well, in respect of any feedback portion 200 in the aerosol provision system 1, it will be appreciated that any power or signals sent thereto may be provided using either a wired or wireless connection between the control circuitry 18 and the feedback portion 200. In the particular embodiments shown in FIGS. 7 and 8, for instance, a wired connection is provided between the feedback portion 200 and the control circuitry 18, and which extends in the case of the feedback portion 200 being located in the cartridge 2 across the interface end 54 (as shown in some of the embodiments of FIG. 7), via a contact electrode 46A located on each of the aerosol provision device 4 and the cartridge 2. Appreciably however, in accordance with embodiments where the aerosol provision system 1 does not comprise the cartridge 2/aerosol provision device 4 arrangement, and/or where the feedback portion is located in the aerosol provision device 4 (e.g. on the user input actuator, such as the input button 20), and/or where a wireless power transmission is employed, the need for any such contact electrode 46A on each of the aerosol provision device 4 and the cartridge 2 may be obviated.

Equally, it will also be appreciated that in accordance with some embodiments, a plurality of different predetermined criterion may be employed. In this way for instance, in response to each of these predetermined criterion being satisfied, the feedback portion 200 may be configured to output electrical charge feedback which is associated with that particular predetermined criterion being satisfied.

For instance, and purely for illustrative purposes, in a particular embodiment where the predetermined criterion is related to the temperature of the vaporiser, in response to a first predetermined criterion being satisfied (e.g. the temperature of the vaporiser exceeding a first predetermined temperature), the feedback portion 200 may be configured to output a first electrical charge feedback at a first charge level.

Equally, in response to a second predetermined criterion being satisfied (e.g. the temperature of the vaporiser exceeding a second predetermined temperature, which may be higher than the first predetermined temperature), the feedback portion 200 may be configured to output a second electrical charge feedback at a second charge level, which is higher than the first charge level (e.g. to give feedback that the temperature of the vaporiser 40 is now too high, and/or has overheated). Appreciably therefore, in response to any other number ‘n’ (e.g. ninth) predetermined criterion being satisfied, the feedback portion 200 may be configured to output an ‘nth’ (e.g. ninth) electrical charge feedback, which may be different from any or all of the other electrical charge feedbacks (e.g. first-eighth).

In the above embodiments therefore, it may be seen that any combination or number of predetermined criterion may be introduced, as required, to suit the intended functionality of the feedback portion 200 to provide any required number of electrical charge feedbacks, each relating to a separate predetermined criterion being satisfied.

1. An aerosol provision system for generating an aerosol; wherein the aerosol provision system comprises a feedback portion for outputting feedback to a user of the aerosol provision system, wherein the feedback comprises an electrical charge which is configured to be delivered to a portion of the aerosol provision system for transmission to the user of the aerosol provision system.

2. The aerosol provision system according to claim 1, wherein the portion is an external surface of the aerosol provision system.

3. The aerosol provision system according to claim 1, wherein the aerosol provision system comprises a mouthpiece, wherein the mouthpiece comprises the portion.

4. The aerosol provision system according to claim 1, further comprising a user input actuator for controlling an operation of the aerosol provision system, wherein the portion comprises the user input actuator.

5. The aerosol provision system according to claim 1, wherein the feedback portion is configured to deliver the charge to the portion at a maximum current of no more than 5 mA.

6. The aerosol provision system according to claim 1, wherein the feedback portion is configured to deliver the electrical charge to the portion for providing a shock to a user of the aerosol provision system for alerting the user of a predetermined status, or predetermined condition, of the aerosol provision system.

7. (canceled)

8. The aerosol provision system according to claim 1, wherein the feedback portion is configured to deliver the electrical charge to the portion for providing a change, or enhancement, in the perception of an aerosol delivered to the user.

9. (canceled)

10. The aerosol provision system according to claim 1; wherein the feedback portion is configured to output the feedback in response to a first predetermined criterion being satisfied-,
wherein the aerosol provision system is configured to:
generate a first signal, in response to determining that the first predetermined criterion is satisfied; and
send the first signal to the feedback portion;
wherein the feedback portion is configured to output the feedback in response to the feedback portion receiving the first signal.

11. (canceled)

12. The aerosol provision system according to claim 8; wherein the feedback comprises first feedback; and
wherein the feedback portion is further configured for outputting second feedback to a user of the aerosol provision system, wherein the second feedback is different from the first feedback, and comprises a second electrical charge which is configured to be delivered to the portion of the aerosol provision system for transmission to the user of the aerosol provision system;
wherein the feedback portion is configured to output the second feedback in response to a second predetermined criterion being satisfied, wherein the second predetermined criterion is different from the first predetermined criterion,
wherein the aerosol provision system is configured to:
generate a second signal, in response to determining that the second predetermined criterion is satisfied; and
send the second signal to the feedback portion;
wherein the feedback portion is configured to output the second feedback in response to the feedback portion receiving the second signal.

13. (canceled)

14. The aerosol provision system according to claim 1, further comprising a cartridge and an aerosol provision device configured to receive the cartridge.

15. The aerosol provision system according to claim 14, wherein the electrical charge is configured to be delivered to a portion of the cartridge.

16. The aerosol provision system according to claim 14, wherein the electrical charge is configured to be delivered to a portion of the aerosol provision device.

17-21. (canceled)

22. The aerosol provision system according to claim 1, wherein the feedback portion is configured to output the feedback to the user of the aerosol provision system when the aerosol provision system is being operated for generating the aerosol.

23-24. (canceled)

25. A mouthpiece for use in an aerosol provision system for generating an aerosol, wherein the mouthpiece comprises a feedback portion for outputting feedback to a user of the mouthpiece, wherein the feedback comprises an electrical charge which is configured to be delivered to a portion of the mouthpiece for transmission to the user of the mouthpiece.

26. (canceled)

27. A method of delivering an electrical charge to a user of an aerosol provision system for generating an aerosol, wherein the method comprises:
in response to determining that a first predetermined criterion is satisfied, outputting feedback, comprising an electrical charge, from a feedback portion; and
delivering the electrical charge to a portion of the aerosol provision system, for transmitting the electrical charge to the user of the aerosol provision device via the portion of the aerosol provision system.

28. The method according to claim 27, wherein the first predetermined criterion comprises a determination of an unauthorised use of the aerosol provision system.

29-31. (canceled)

32. The method according to claim 27, wherein the method is a method of delivering an electrical charge to a mouth of the user, and wherein the portion is located on a mouthpiece of the aerosol provision system.

33. The method according to claim 27, wherein the method is a method of delivering an electrical charge to a hand of the user, and wherein the portion is located on an external surface of the aerosol provision system.

34-44. (canceled)
